(19) United States
(12) Patent Application Publication
(10) Pub. No.: US 2008/0002675 A1
(43) Pub. Date: Jan. 3, 2008

(54) Automated Connectivity Testing

(75) Inventors: Naizhi Li, Redmond, WA (US); Aaron S. Kim, Seattle, WA (US); Roxana Teodorescu, Redmond, WA (US); Nathan L. Flint, Kirkland, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/428,145

(22) Filed: Jun. 30, 2006

(51) Int. Cl. H04L 12/66

(52) U.S. Cl. 370/353

(57) ABSTRACT

A connectivity automation tool provides a robust, general and reusable platform that enables programs to communicate in a variety of connectivity environments. Applications, such as automated tests, can rely on this tool for testing under various connectivity environments. In accordance with at least some embodiments, the connectivity automation tool enables connectivity testing to be fully automated, thus reducing the resources required to carry out connectivity testing and increasing the number of connectivity scenarios that can be covered.

### BACKGROUND

Simulating “real-world” scenarios is a key ingredient for effectively testing computer software. For example, one type of testing involves connectivity testing, which tests the connectivity between various types of devices. This type of testing can involve performing various tests on real networks with varying bandwidths, types of connectivity and the like. As one of skill can appreciate, there are many different types of connectivity scenarios stemming, at least partially, from the different connection types that exist, as well parameters such as latency, packet loss rate and packet routing mechanism.

Currently, most if not all of the testing that requires different connectivity environments must have human intervention. That is, there must typically be a human tester to establish the physical connections that are to be tested. As the number of connection types and other pertinent parameters multiply the number of connectivity environments, requiring a human element to physically establish the connections that are to be tested becomes onerous and inefficient.

### SUMMARY

A connectivity automation tool provides a robust, general and reusable platform that enables programs to communicate in a variety of connectivity environments. Applications, such as automated tests, can rely on this tool for testing under various connectivity environments. In accordance with at least some embodiments, the connectivity automation tool enables connectivity testing to be fully automated, thus reducing the resources required to carry out connectivity testing and increasing the number of connectivity scenarios that can be covered.

In at least one embodiment, the connectivity automation tool utilizes a hardware physical layer switch to automatically control the connectivity types of various test machines. In these embodiments, the connectivity automation tool utilizes software that includes a server module that runs on an Internet-connected computer and accepts requests from clients, and a client module that runs on test machines and provides connectivity services to applications. The client module can programmatically change a test machine's connectivity type, as well as communicate with other test machines using, for example, TCP bridging.

### BRIEF DESCRIPTION OF THE DRAWINGS

FIG. 1 illustrates an exemplary computing environment in which the various embodiments can be implemented in accordance with one embodiment.

FIG. 2 illustrates a system that includes an exemplary software architecture in accordance with one embodiment.

FIG. 3 is a flow diagram that describes steps in a method in accordance with one embodiment.

### DETAILED DESCRIPTION

Overview

A connectivity automation tool provides a robust, general and reusable platform that enables programs to communicate in a variety of connectivity environments. Applications, such as automated tests, can rely on this tool for testing under various connectivity environments. In accordance with at least some embodiments, the connectivity automation tool enables connectivity testing to be fully automated, thus reducing the resources required to carry out connectivity testing and increasing the number of connectivity scenarios that can be covered.

In at least one embodiment, the connectivity automation tool utilizes a hardware physical layer switch to automatically control the connectivity types of various test machines. In these embodiments, the connectivity automation tool utilizes software that includes a server module that runs on an Internet-connected computer and accepts requests from clients, and a client module that runs on test machines and provides connectivity services to applications. Such services can include, by way of example and not limitation, programmatically changing a test machine's connectivity type, as well as communicating with other test machines using, for example, TCP bridging.

Utilizing the above services, a test application can, for example, request a test machine to be switched to a desired connectivity type, run a test case, and switch back to the “home” connectivity type to collect test results. For example, in some scenarios, a peer-to-peer test suite can execute a suite of peer-to-peer test cases, such as those encountered in an instant messaging environment, using the connectivity automation tool. Before running a test case, the connectivity automation tool can switch both test machines to desired connectivity types, run the test cases, and, after the test cases are done, switch both test machines back to the home network to collect test results. As the test cases in this example involves two test machines at any time, the machines can communicate with each other using remoting techniques, such as those provided by .NET Remoting.

In the discussion that follows, a section entitled “Architecture” is provided and describes an exemplary computing environment and software architecture that can be used in various embodiments. Following this, a section entitled “Implementation Example” is provided and describes but one exemplary implementation that can provide a connectivity automation tool.

Architecture

In the discussion below, a first sub-section entitled “Exemplary Computing Environment” is provided and describes one exemplary environment in which the connectivity automation tool can be utilized. Following this, a section entitled “Software Architecture” is provided and describes but one exemplary software architecture that can be utilized. It is to be appreciated and understood that the description below constitutes but one example and is not intended to limit application of the claimed subject matter to the described environment or architecture. As such, other environments and architectures can be utilized without departing from the spirit and scope of the claimed subject matter.

Exemplary Computing Environment

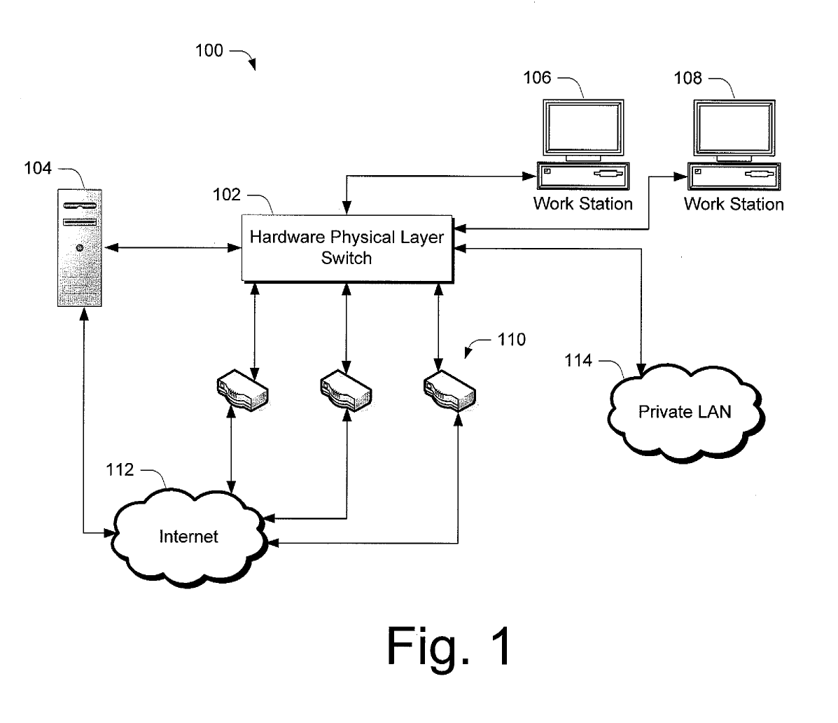

FIG. 1 illustrates, generally at 100, an exemplary computing environment in which the various embodiments can be implemented in accordance with one embodiment.

In this example, environment 100 includes a hardware physical layer switch 102 interconnected between a number of different components including, by way of example and not limitation, a server 104 (also referred to as a “proxy server” or “proxy”), a plurality of work stations two of which are shown at 106, 108 (also referred to as “test machines”), and one or more routers 110 which are operably connected with a network, such as the Internet 112. In addition, in this example, a private LAN 114 is connected with the hardware physical layer switch 102.

In the illustrated and described embodiment, any suitable physical layer switch (also referred to as a “physical layer matrix switch”) can be utilized. Such switches can support multiple port connections that can be used to interconnect various devices.

For example, some commercially available switches can support 16, 32, 64, 144, 288 and more port configurations. Other characteristics of such switches include, by way of example and not limitation, supporting 1, 2, 4 and 10-Gb/s Fibre Channel, 10/100/1000/10G Ethernet, T1, E1, J1, FDDI and SONET/SDH OC-3, OC-12 and OC-48. In addition, at least some switches can support multi-protocol blades that support many of the aforementioned protocols and more, including NTSC/PAL, HDTV, ESCON and Infiniband. One commercially-available switch that is suitable for use in connection with the described embodiments is the Intellapatch physical layer switch available from APCON, Inc. of Wilsonville, Oreg.

Accordingly, in the FIG. 1 example, switch 102 is configured to enable physical layer switching of ports. The switch has many ports, as indicated above, and can connect any two ports together. For example, switch 102 can connect one of the workstations 106, 108 to Private LAN 114, one of the routers 110, or Internet 112.

Server 104 is, in this particular example, a dedicated computer that runs connectivity automation tool software to implement the functionality described above and below. Server 104 is connected to Internet 112 through any suitable connection, such as through a commercial DSL, and controls the hardware of switch 102 via a serial port.

Work stations 106, 108 are, in this example, the main test machines available for testing purposes. The workstations are connected directly to the hardware of switch 102 and each of the work stations runs a separate process, referred to as the connectivity automation tool client or “CAT client”, that enables the connectivity automation tool functionality described above and below.

The discussion that follows describes a software architecture in accordance with one embodiment. The architecture illustrates control, data and control/data multiplexed flows that occur amongst and between various components of the FIG. 1 system.

Software Architecture

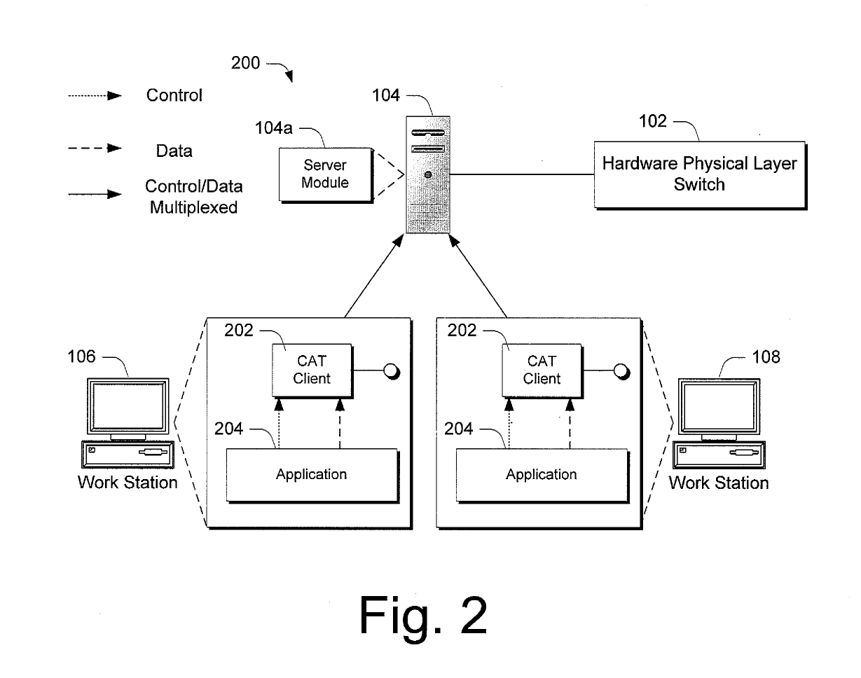

FIG. 2 illustrates an exemplary software architecture that comprises part of a system that is illustrated generally at 200. In the illustration, the flow of control information is depicted by the finely-dashed arrows, the flow of data is depicted by the thicker of the dashed arrows, and the flow of control/data multiplexed information is depicted by the solid arrows.

In this example, system 200 includes switch 102, server 104 connected to switch 102, and test machines 106, 108. In this particular example, server 104 includes a server module 104a implemented in software code, and each test machine 106, 108 includes a connectivity automation tool (CAT) client 202 that exposes an interface through which one or more applications 204 communicate with the client. Applications 204 constitute the software code that implements the test cases, scripts or programs that are utilized to conduct connectivity testing.

In operation, server module 104a controls switch 102 through a serial port or some other suitable type of connection. In this particular example, the server module 104a “listens” on a TCP port for test machines with which to connect. In this particular example, server 104 is connected through the Internet, so that whatever connectivity each test machine 106, 108 has, it can connect to server 104. In this embodiment, server 104 receives and processes requests from test machines and relays related information amongst the various test machines.

In the illustrated and described embodiment, test machines 106, 108 can be switched via switch 102 to various connectivity types, such as, by way of example and not limitation, UPnP and non-UPnP IP Restricted Cone NAT, and Private LAN. In practice, the test machines can create a TCP connection with the server 104 and communicate with the server through this connection. In at least some embodiments, test machines 106, 108 can communicate with server 104 via HTTP protocol. Accordingly, any suitable techniques can be utilized to enable the test machines and the server to communicate.

In the illustrated and described embodiment, on each test machine 106, 108, a separate process, referred to as CAT client 202, serves as a service provider. In this particular example, the CAT client maintains a TCP connection with server 104, and reconnects if the current connection goes down. In this example, all communications with server 104 go through this process.

In the illustrated and described embodiment, CAT client 202 provides the following services to applications 204 on the test machines. First the CAT client can programmatically change the machine's connection type. Second, the CAT client can communicate with another test machine through, for example, TCP bridging. One example of TCP Bridging is to bridge .NET Remoting data so that existing two-machine test cases written for a single LAN environment can run without modification, as will be appreciated by the skilled artisan.

The discussion that follows describes an implementation example that utilizes the system of FIGS. 1 and 2.

Implementation Example

In the illustrated and described embodiment, CAT client 202 exposes an interface or API (ICatServices) that application 204 uses to communicate with the CAT client. To request a change of connection type, an application simply calls ICatServices.ChangeCon(string connectionType). In the illustrated and described embodiment, a number of different connection scenarios are supported including, by way of example and not limitation, IP Restricted Cone NATs, Port Restricted Cone NATs, UPnP NATs, Firewalls with no exceptions, DSL, Private LAN, modem and the like.

To communicate with another test machine and implement client-to-client operations, an application first calls ICatServices.Map( ), to set up a map between a local port and a remote port on a remote test machine. The CAT client 202 then listens on the local port and waits for a connection request on that port. After that, the application can connect to the local port and all packets will be relayed to the specified port on the specified remote test machine. An application can also request for some basic operations, such as run a program remotely and remotely fetch/put a file.

In this particular example, client-to-client operations are supported through the building of a bridge infrastructure, with the bridge serving as a client-to-client communication channel.

To setup a bridge, a bridge interface is provided, e.g. IClientBridge interface, and has a method ClientProcessor.CreateBridge( ) that is called to set the bridge up. A bridge has a type attribute and currently, the following types of bridges are defined:
0—TCP data bridge
1—Remote execution bridge
2—Change remote connection bridge

TCP Bridge

Based on the bridge infrastructure, a TCP bridge enables test applications to communicate with each other on different test machines. In the illustrated and described embodiment, the TCP bridge is utilized as follows. An application first requests to map a remote TCP port to a local TCP port. The CAT client then listens on the local port. An application can then connect to the local port. The CAT client can detect that the local port is connected, and can create a bridge with the other machine. Now, the CAT client running on the other machine can attempt to connect to the mapped remote port. Information that is now sent and received on the local or remote port is relayed through server, e.g. server 104 (FIGS. 1 and 2).

In order to specify the type of connection that is desired in the particular testing scenario, one embodiment utilizes a connection type string. In one embodiment, a connection type string can be utilized that has the following constituent parts:
ConnectionType=TypeKeyWord [TypeExtensions]
TypeKeyWord=PrivateLan | Direct | UPnPIPRestricted | UPnPPortRestricted | UPnPSymmetric | IPRestricted | PortRestricted | Symmetric | Dialup
TypeExtensions=;TypeExtension [TypeExtensions]
TypeExtension=Name=Value
Name=RouterModel|FirmwareVersion|PortId
Value=String

Protocol Design

In the illustrated implementation example, there are effectively three kinds of communication in the system which are illustrated in FIG. 2. First, there is the communication that takes place using the data connection between the application 204 and the CAT client 202. Second, there is the communication that takes place using the control connection between the application 204 and the CAT client 202. Third, there is the communication that takes place using the control/data connection between the CAT client 202 and the server 104.

The first type of communication—that which uses the data connection between the application and the CAT client—does not necessarily utilize any particular protocol because the application simply sends data to the CAT client and vice versa. Examples of such type of data include, by way of example and not limitation, remoting data such as .Net remoting data.

The second type of communication—that which uses the control connection between the application and the CAT client—uses an API (ICatServices).

The third type of communication—that which uses the control/data connection between the CAT client and the server—uses the protocol that is defined just below.

In this implementation example, a text-based protocol is utilized. Each packet that is sent between the CAT client and the server has a one-line header that assumes the following form:
[COMMAND] [FLAG] [ID] [SIZE]\r\n.
[COMMAND] is a three letter command name, e.g. REG;
[FLAG] is a hex number representing the flags used in the packet, e.g. A3;
[ID] is the hex ID number. Every command has a different ID except the data packets; and
[SIZE] is the size of the packet following this header—also in hex form.

In the illustrated example, there is one space between each field and the header is less than or equal to 48 bytes. An example packet assumes the following form:

REG 0 31F 41\r\n

[PacketContent]

In the illustrated and described embodiment, commands that are utilized include, by way of example and not limitation, commands that register a client, request a port mapping (application to CAT client), request a bridge, teardown a bridge, bridge data, change a connection, query machine status, and heartbeat, which are explained below in more detail. Remotely executing a program and changing remote connections are implemented through the bridge infrastructure described above.

In the illustrated and described embodiment, flags include, by way of example and not limitation:
FLAG_REPLY_OK (0x01) means this packet is a reply to a command and the command succeeded
FLAG_REPLY_ERROR (0x02) means this packet is a reply to a command and the command failed

In the discussion that follows, an explanation of the various commands that are listed above is provided.

The Register Client command or, REG, is the first message the client sends to the server after a connection is established. For this packet, the ID field in the header is not used and is 0. The payload consists of lines of name-value pairs. Valid names are:
ProtocolVersion
MachineName
MacAddress
ConnectionType

The MachineName is the name of the machine. ConnectionType is a returned value from the server. That is, after a client successfully registers itself, the server will send a REG reply with connectiontype filled in with this client's connection type string.

The Request a bridge command or, RBG, is used by the client to send to the server to request a bridge. The payload consists of lines of name-value pairs. Valid names are:
RemoteComputerName
Context (which pertains to bridge-specific data which can be different depending on the types of bridges)
BridgeID
Type (which can be one of a multiple number of defined bridges)

When the client sends this command to the server, the server forwards it to the proper computer. The other computer then responds with success/fail. The Bridge ID is assigned by the server and returned to the clients as the ID for this bridge.

The Teardown a TCP bridge command or, TBG, is used to tear down a TCP bridge. The payload consists of a line that includes a name-value pair BridgeID, which identifies the bridge that is to be torn down. In this example, the client informs the server and the other end the bridge is being closed. The other computer then sends back a reply if successful.

The Bridge Data command or, BGD, is used in connection with bridge data that can be sent between and amongst the clients and server. The payload used with this command is binary data and the ID for the header is the bridge ID. This is the encapsulating command for bridge data. The server simply forwards this command to a destination client. For example, .Net remoting bridge data is encapsulated in this command and sent across by the server to the other client.

The Change Connection command or, CON, is used to change a connection and includes a reference to a ConnectionType. When a computer requests to change its own connection type, it can utilize a process as follows.

First, the application, such as application 204 (FIG. 2) calls CatLib.CatServices.ChangeCon(conType) on the CAT client 202. An example of connection type that might be specified is: UPnPIPRestriced;Model=I-401. Next, the CAT client 202 sends a change connection command to the server 104. Server 104 then finds a match port and replies with the result, and closes the connection with the client.

Simultaneously, the server 104 switches this computer to the port and the CAT client waits for a period of time before attempting to connect back to the server 104. After the CAT client 202 is connected with the server 104, the server sends its current connection and the CAT client decides whether the switch was successful, and application's ChangeCon( ) call returns with success/error code.

The Query Machine Status command or, QRY, is used to query the status of a particular machine and utilizes name-value pairs, valid names of which include:
MachineName
Registered (true/false)
ConnectionType

The CAT client 202 sends this packet to query the status of a particular machine. Only “MachineName” is used when sending the packet, and the server should respond with a reply with Registered and ConnectionType.

The Heartbeat command or, HBT, is what is known as a basic heartbeat function. The client sends a HBT packet if it has not been sending anything to the server in the past few minutes. On receiving the HBT, the server simply responds.

A typical scenario in which the HBT command can be used is as follows. Assume that the client is connected to the server from behind a router and that the router expires the mapping. Now, when the server tries to send a command to the client, the TCP connection has been reset. Thus, the server thinks that the client is not connected while the client still thinks it is connected and does not try again, unable to receive the command. With the help of HBT, the client is able to quickly realize that it is disconnected from the server and retries to connect.

Code Modules

In the illustrated and described implementation example, the functionality described above and below can be implemented by various code modules, examples of which include, by way of example and not limitation, a protocol processing module, a hardware physical layer switch module, a server module, a CATLib module, and a client module, each of which is discussed under its own heading. These modules reside as computer-readable and executable instructions that reside on some type of computer-readable media.

Protocol Processing Module

This module handles the protocol described above and is shared between the server and the CAT client. The main classes in this module include ProtocolProcessor, EncryptedTCPStream and CATPacket. The ProtocolProcessor is the module that processes protocol packets; the EncryptedTCPStream is a secure layer that encrypts data transmissions, and the CATPacket is an abstraction of each of the protocol packets.

In the illustrated and described implementation example, this module is code-shared between the server and the client and it does not get compiled on its Own.

Hardware Physical Layer Switch Module

This module handles all communication with the hardware physical layer switch. It utilizes the switch's protocol using a socket. Synchronization is achieved by locking each operation.

Server Module

This module runs on the server machine and relays information between clients, and handles connection changes through the hardware physical layer switch. In this implementation example, the main classes in this module include, by way of example and not limitation:
ClientHandler—an instance of this class is created to handle each connected client;
ServerApp—this class handles all App level details such as initialization;
ServerTCPBridge—represents a bridge inside the server
ServerConfig—this module parses serverconfig.xml
ServerListener—this module listens on the port waiting for clients to connect; and
ServerUI—this is the user interface class for the server.

The CATLIb module defines the interface (ICatServices) between applications and the CAT client. This module compiles into a DLL and this DLL is referenced by applications to use the CAT client. When the application calls CATLib, a Remoting connection is established with the CatClient process and sends all calls to ICatServices to CatClient.

Client Module

This module is a daemon process (CatClient.exe) running on each client machine. It accepts requests from the applications via TCP/IP and maintains a connection with the proxy server. Once CatClient.exe is up and running, it will try to connect to the server and will retry if it fails. The IP address of the server is configured in the client configuration file. This TCP connection with the proxy server is kept alive throughout the session. At the same time, CatClient.exe is listening to a well-known port (default 9876) on localhost. If an application has a request, it connects to this port using CATLib and issues commands through ICatServices.

CatClient.exe also implements the bridge infrastructure. To add a new bridge type, it implements the IClientBridge interface.

The main classes in this module include, by way of example and not limitation:
ClientProcessor: connects with Cat Server;
CatServicesImp1: implements ICatServices interface;
PortMapping: implements a port mapping and listens on the port;
IClientBridge: defines the IClientBridge interface;
ClientTCPBridge: implements the TCP bridge;
ClientEXEBridge: implements the remote execution bridge; and
RemoteConBridge: implements the change remote connection bridge.

Security

In at least some embodiments, enhanced security can be provided. Recall that server 104, acting as a proxy, is connected with the open Internet and communicates with the various test machines. During testing, this may create a channel between test machines on the Internet and test machines in a private LAN. As test machines change between the Internet and a private LAN frequently, a compromised test machine could be dangerous to the private LAN. To mitigate such risks, a number of different measures can be implemented.

For example, private/public key systems can be used to authenticate clients. Thus, the server can authenticate each client by encrypting a 32-byte random challenge using the client's public key, and the client will decrypt this random challenge with its private key.

Alternately or additionally, all session data can be encrypted. Specifically, all data sent/received by the server can be encrypted using the AES (Advanced Encryption Standard) symmetric encryption system. For each session, the server can generate a session key, encrypt this session key using client's public key and send it to the client.

Alternately or additionally, IP restrictions can be utilized. Specifically, the server can be configured so that it only accepts connections from a pre-defined set of IP ranges.

Alternately or additionally, client-to-client authentication and encryption can be utilized. Thus, in the unlikely event that the server is compromised, the server cannot be used as a means to run a program directly on a client machine.

Other security measures include, by way of example and not limitation, having the server run using a low-privilege account, and having the server utilize a firewall enabled with CAT as the only exception.

CAT API

In the illustrated and described implementation example, the CAT client exposes an API defined in the ICatServices interface. In order to use this API, an application should reference CatLib.dll and create a CatLib instance and access CatLib.CatServices.

The ICatServices interface is defined as follows:

```
    public interface ICatServices
    {
      /// <summary>
      /// Change the connection on this computer
      /// </summary>
      /// <param name=“connectionString”>Connection string, e.g.
UPnPIPRestriced. </param>
      /// <returns>The connection string after change.</returns>
      string ChangeConnection(string connectionString);
      /// <summary>
      /// Change the connection on a remote computer. This call
returns immediately, and remote computer will change its own computer
after 2 seconds
      /// </summary>
      /// <param name=“remoteComputer”>The remote
computer's name</param>
      /// <param name=“connectionString”>Connection string,
e.g. UPnPIPRestriced. </param>
      /// <returns>−1 if remote computer is not connected,
0 otherwise. Note that it may fail even if it returns 0</returns>
      int ChangeRemoteConnection(string remoteComputer,
string connectionString);
      /// <summary>
      /// Query the status and connection type of any machine in the
system
      /// </summary>
      /// <param name=“machineName”>the name of the machine to be
queried</param>
      /// <returns>null if machine is not registered with the system,
empty string it machine is registered but connection type is unknown,
or the connection type of the machine</returns>
      string QueryMachineStatus(string machineName);
      /// <summary>
      /// Remotely execute a command
      /// </summary>
      /// <param name=“remoteComputer”>Remote computer name</
      param>
      /// <param name=“command”>Command line</param>
      /// <param name=“waitForExit”>A flag note whether to wait for
remote command to exit</param>
      /// <returns>Exit code</returns>
      int RemoteExecute(string remoteComputer, string command, bool
waitForExit);
      /// <summary>
      /// Create port mapping in local machine
      /// </summary>
      /// <param name=“remoteComputer”>Remote computer name to
map to</param>
      /// </param name=“remotePort”>remote port to map to</param>
      /// <param name=“localPort”>local port</param>
      /// <param name=“multiBridge”>whether local port can accept
more than 1 connection. suggested true</param>
      /// <returns>true if successful</returns>
      bool CreatePortMapping(string remoteComputer, int remotePort,
int localPort, bool multiBridge);
      /// <summary>
      /// Remove port mapping
      /// </summary>
      /// <param name=“localPort”>local port number</param>
      void RemovePortMapping(int localPort);
    }
```

A usage example is as follows:

CatLib clib = new CatLib( );
clib.CatServices.ChangeCon(“UPnPIPRestricted”);

Internally, CatLib uses .NET Remoting to access Cat Client's ICatServices implementation.

Connection Type String

An example of connection type string, such as that utilized in the above-described API, is as follows:
UPnPIPRestricted;RouterModel=MN-700

If this type string is used in a ChangeConnection( ) call, the system will attempt to match all switch ports which have type UPnPIPRestricted and a model string of MN-700, and pick any one of them that is available.

.NET Remoting Support

In at least some embodiments, .NET Remoting can be supported via TCP bridge. As an example, consider the following.

Assume that there are two machines—A and B. Machine B is running RemoteCAOServer, which is a .NET Remoting Server that listens on TCP port 8085. Machine A runs RunAutomation, which is a .NET Remoing Client that connects to a server port 8085.

First, local port 8085 is mapped to remote port 8085, by calling
clib.CatServices.CreatePortMapping(“B”, 8085, 8085, true);

When running RemoteCAOServer on Machine B, the machineName property is set to “localhost” when registering the TCP Channel. Then, on Machine A, RunAutomation is run. In this instance, tell RunAutomation that the remote machine is “localhost” instead of Machine B.

Note that in order to support .NET Remoting, the mapped local and remote port are the same.

Exemplary Method

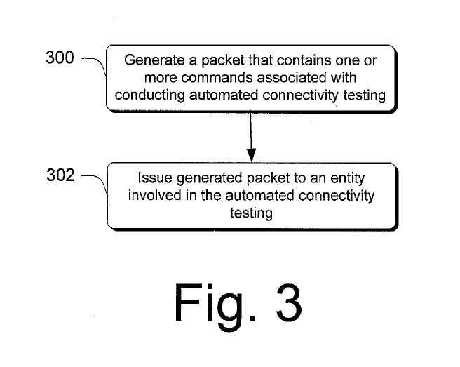

FIG. 3 is a flow diagram that describes steps in a method in accordance with one embodiment. The method can be implemented in connection with any suitable hardware, software, firmware or combination thereof. In but one embodiment, the method can be implemented in software in connection with a system, such as the system described above.

Step 300 generates a packet that contains one or more commands associated with conducting automated connectivity testing. Examples of commands are provided above. In at least some embodiments, the commands can be used in connection with a testing scenario in which individual test machines can programmatically change the associated connection types relative to which the connectivity testing takes place. Examples of different connection types are given above.

Step 302 issues a generated packet to an entity involved in the automated connectivity testing. In the example above, packets can be issued from a test machine (by way of its associated CAT client) to a proxy server, from the proxy server to the test machine, and/or from a test application to the CAT client.

User Scenario

To assist the reader in appreciating the context of the above-described embodiments, the following user scenario is provided.

Assume that a human tester wishes to initiate a test case which verifies that a new “multi-party video conference” feature works under various connectivity situations. To do this, she develops a matrix of connectivity situations or environments, including UPnP IP Restricted NAT, non-UPnP NAT, Private LAN, third party firewall, and the like. The automated test cases that she develops use, in this example, .NET Remoting to communicate between the various machines to accept the associated invites and to verify video transmission.

She now deploys the connectivity tool in her testing lab and writes the test job that is to be used to test the multi-party video conference feature. By giving the test job different parameters, the job can be run under different connectivity environments automatically. When the testing is complete, generated test logs and results are collected and stored for subsequent analysis.

### CONCLUSION

The above-described connectivity automation tool provides a robust, general and reusable platform that enables programs to communicate in a variety of connectivity environments. Applications, such as automated tests, can rely on this tool for testing under various connectivity environments. In accordance with at least some embodiments, the connectivity automation tool enables connectivity testing to be fully automated, thus reducing the resources required to carry out connectivity testing and increasing the number of connectivity scenarios that can be covered.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A system comprising:
a hardware physical layer switch configured to support and switch between multiple port connections that can be used to interconnect various computing devices; and
a server operatively connected to the hardware physical layer switch and comprising a server module that accepts connectivity-related requests from multiple testing machines and enables automated connectivity testing in which connection types associated with individual testing machines can be programmatically changed.

2. The system of claim 1 further comprising multiple testing machines individually operatively connected with the hardware physical layer switch and configured to generate connectivity-related requests to the server.

3. The system of claim 2, wherein the individual testing machines comprise:
a connectivity automation tool client; and
one or more applications that are configured to enable implementation of test cases;
wherein the connectivity automation tool client exposes an interface through which the one or more applications communicate with the client.

4. The system of claim 3, wherein the connectivity automation tool client is configured to programmatically change its associated machine's connection type.

5. The system of claim 3, wherein the connectivity automation tool client is configured to communicate with another testing machine.

6. The system of claim 5, wherein communication between individual testing machines takes place via bridging.

7. One or more computer-readable media having computer-readable instructions thereon which, when executed, implement a system comprising:
a connectivity automation tool client configured to be utilized in connectivity testing, wherein the connectivity automation tool client is configured to:
programmatically change, for purposes of connectivity testing, an associated test machine's connection type; and
enable communication with other test machines.

8. The one or more computer-readable media of claim 7, wherein the connectivity automation tool client is configured to enable communication with other test machines using TCP bridging.

9. The one or more computer-readable media of claim 7, wherein the connectivity automation tool client exposes an interface having a method that test applications can call to programmatically change a test machine's connection type.

10. The one or more computer-readable media of claim 9, wherein the interface includes a method that applications can call to communicate with other test machines.

11. The one or more computer-readable media of claim 10, wherein the method that applications call to communicate with other test machines sets up a map between a local port and a remote port on a remote test machine.

12. A computer-implemented method comprising
generating a packet that contains one or more commands associated with conducting automated connectivity testing, wherein one of the commands can comprise a change connection command that allows individual test machines to programmatically change associated connection types relative to which such testing takes place; and
issuing the generated packet to an entity involved in the automated connectivity testing.

13. The method of claim 12, wherein said entity comprises a proxy server that is operably connected to a hardware physical layer switch that can change connection types, and wherein said acts of generating and issuing are performed by a client executing on a test machine.

14. The method of claim 13, wherein one of the commands can comprise a register client command that registers a test machine.

15. The method of claim 13, wherein one of the commands can comprise a command to request a bridge with another test machine.

16. The method of claim 13, wherein one of the commands can comprise a command to tear down a bridge with another test machine.

17. The method of claim 13, wherein one of the commands can comprise a bridge data command that is used in connection with data that is sent between different test machines.

18. The method of claim 13, wherein one of the commands can comprise a query machine status command that is used to query a status of a particular test machine.

19. One or more computer-readable media embodying computer-readable instructions which, when executed, implement the method of claim 12.

20. A computing device embodying the one or more computer-readable media of claim 19.
